(19) United States
(12) Patent Application Publication
(10) Pub. No.: US 2006/0249120 A1
(43) Pub. Date: Nov. 9, 2006

(54) Fuel injection control during cranking of internal combustion engine

(75) Inventors: Kazuhiro Semii, Yokohama-shi (JP); Manabu Okamura, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/415,434

(22) Filed: May 2, 2006

(30) Foreign Application Priority Data
May 2, 2005 (JP) 2005-134145

(51) Int. Cl. F02M 57/02; F02M 37/04

(52) U.S. Cl. 123/446; 123/501

(57) ABSTRACT

Fuel to be supplied to fuel injectors (31A-31D) of an internal combustion engine is pressurized using a plunger pump (14) which operates in accordance with the rotation of the internal combustion engine. Each of the injectors (31A-31D) injects the supplied fuel into each of a plurality of cylinders at a predetermined crank angle. At a predetermined calculation timing which is prior to a fuel injection timing of each fuel injector (31A-31D), an engine controller (41) predicts a fuel pressure (Pest) at the fuel injection timing with a high degree of precision (S15). When the predicted fuel pressure (Pest) reaches a predetermined injection permission pressure, the fuel injector (31A-31D) is controlled to execute fuel injection (S17, S23), and thus delays in a fuel injection start timing during cranking are prevented.

### FIELD OF THE INVENTION

This invention relates to fuel injection control performed during cranking of an internal combustion engine.

### BACKGROUND OF THE INVENTION

JP2000-320385A, published by the Japan Patent Office in 2000, discloses a fuel injection control method employed when fuel which has been pressurized by a high-pressure fuel pump is injected into the interior of an internal combustion engine through a fuel injector.

According to this prior art, fuel pressure is detected prior to the fuel injection timing of a certain cylinder by a predetermined crank angle, and a fuel injection pulse width of the certain cylinder is calculated on the basis of the detected fuel pressure and an applied target fuel injection amount. The high-pressure fuel pump is constituted by a plunger pump which is driven by a camshaft of the engine.

### SUMMARY OF THE INVENTION

During a steady state operation of the engine, the pressure of the fuel discharged by the plunger pump is stable, and therefore fuel injection can be controlled with precision on the basis of the prior art.

However, when the fuel injection control of the prior art is applied to fuel injection during cranking of the engine during which the fuel pressure varies easily between the fuel pressure detection timing and the fuel injection timing, an error between the actual fuel injection amount and the target fuel injection amount increases, depending on the cylinder.

The plunger pump performs suction and discharge repeatedly in accordance with the rotation angle of the cam of the internal combustion engine. During the discharge stroke, the fuel pressure rises, but during the suction stroke, the fuel pressure does not rise. Hence, if the suction stroke overlaps the period extending from the fuel pressure detection timing to the fuel injection timing, the error between the actual fuel injection amount and target fuel injection amount is likely to increase.

Moreover, if the fuel pressure does not reach a predetermined fuel injection permission pressure, fuel injection is generally not performed. Accordingly, cases may arise in which, during the discharge stroke of the plunger pump, the fuel pressure at the detection timing is lower than the fuel injection permission pressure even when the actual fuel pressure at the injection timing exceeds the fuel injection permission pressure, and as a result, fuel injection is not permitted.

When the fuel injection timing is fixed in a single cylinder engine or an engine having a small number of cylinders, it is possible to set the rotation angle of the cam which drives the plunger pump such that the suction stroke of the plunger pump and the fuel pressure detection timing do not overlap. However, in an engine having a large number of cylinders or an engine which uses both intake stroke injection and compression stroke injection, such an arrangement cannot be achieved easily. As a result, in this type of engine the beginning of fuel injection during cranking may be delayed.

It is therefore an object of the present invention to grasp the fuel pressure with a high degree of precision during engine cranking.

In order to achieve the above object, this invention provides a fuel supply control device for controlling fuel supply to an internal combustion engine while the engine is being cranked. The device comprises a reciprocation pump which pressurizes, according to the rotation of the engine, fuel which is to be supplied to the engine, a fuel injector which injects the fuel pressurized by the reciprocation pump into a cylinder of the engine at a predetermined crank angle of the engine, and a programmable controller which controls the fuel injector. The controller is programmed to predict a pressure of the fuel pressurized by the reciprocation pump at a fuel injection timing corresponding to the predetermined crank angle of the engine as a predicted fuel pressure, at a predetermined calculation timing which is prior to the fuel injection timing, and control the fuel injector to perform fuel injection when the predicted fuel pressure reaches a predetermined injection permission pressure.

This invention also provides a fuel supply control method for controlling fuel supply to an internal combustion engine while the engine is being cranked, using a reciprocation pump which pressurizes, according to the rotation of the engine, fuel which is to be supplied to the engine, and a fuel injector which injects the fuel pressurized by the reciprocation pump into a cylinder of the engine at a predetermined crank angle of the engine. The method comprises predicting a pressure of the fuel pressurized by the reciprocation pump at a fuel injection timing corresponding to the predetermined crank angle of the engine as a predicted fuel pressure, at a predetermined calculation timing which is prior to the fuel injection timing, and controlling the fuel injector to perform fuel injection when the predicted fuel pressure reaches a predetermined injection permission pressure.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel supply device according to this invention.

FIG. 2 is a plan view of a pump driving cam according to this invention.

FIGS. 3A-3D are timing charts illustrating an operation of a high-pressure fuel pump according to this invention.

FIGS. 4A-4D are timing charts comparing a fuel injection start timing of the fuel supply device during cranking of an engine with the prior art.

FIGS. 5A-5C are timing charts illustrating the relationship between a plunger lift, a fuel injection timing, and a Ref signal, according to this invention.

FIG. 6 is a flowchart illustrating a stratified charge combustion permission flag setting routine, executed by an engine controller according to this invention.

FIG. 7 is a flowchart illustrating a fuel injection timing calculation routine executed by the engine controller.

FIG. 8 is a flowchart illustrating a fuel injection routine executed by the engine controller.

### DESCRIPTION OF THE PREFERRED EMBODIMENTS

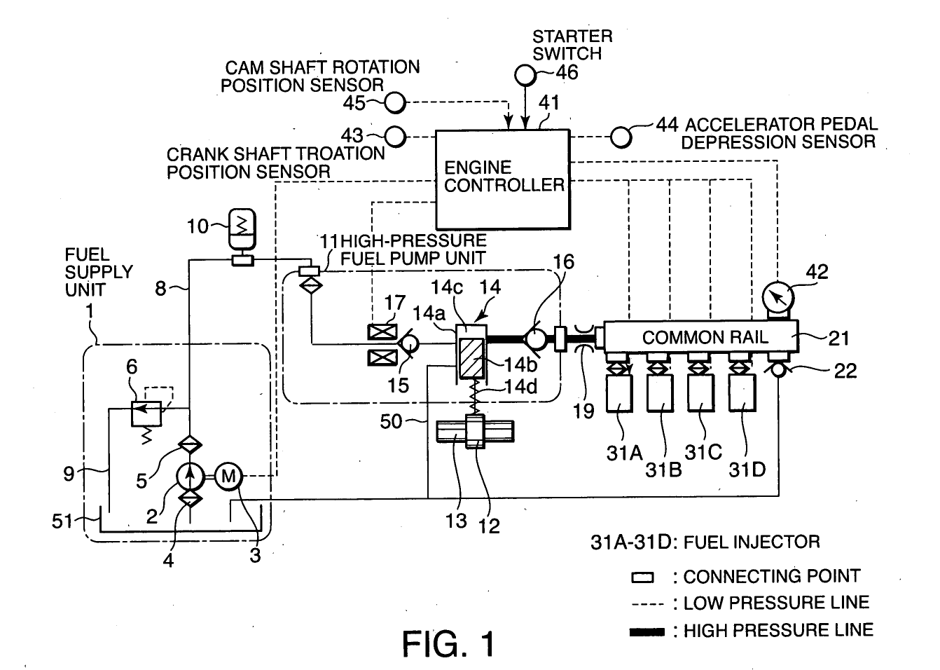

Referring to FIG. 1 of the drawings, a fuel supply device for an internal combustion engine installed in a vehicle comprises a fuel supply unit 1, a high-pressure fuel pump unit 11, a common rail 21, and fuel injectors 31A-31D. The internal combustion engine is a four stroke cycle, four-cylinder engine.

The fuel supply unit 1 pressurizes fuel from a fuel tank 51 to a predetermined low pressure using a feed pump 2, and supplies the fuel to the high-pressure fuel pump unit 11 through a fuel supply passage 8. The feed pump 2 is driven by an electric motor 3. A fuel filter 4 is provided at an suction port of the feed pump 2, and a fuel filter 5 is provided at a discharge port of the feed pump 2.

To ensure that the discharge pressure of the feed pump 2 does not become excessive, the fuel supply unit 1 further comprises a low-pressure pressure regulator 6 which returns a part of the fuel discharged to the fuel supply passage 8 by the feed pump 2 to the fuel tank 51 through a return passage 9 in accordance with the discharge pressure.

The fuel supply device further comprises a damper 10 on the fuel supply passage 8 which suppresses the fuel pressure pulse of the fuel that is supplied to the high-pressure fuel pump unit 11.

The high-pressure pump unit 11 comprises a plunger pump 14, a normally-closed suction check valve 15 disposed at a suction port of the plunger pump 14, and a normally-closed discharge check valve 16 disposed at a discharge port of the plunger pump 14.

The plunger pump 14 is driven by a pump driving cam 12. The plunger pump 14 comprises a cylinder 14a, a plunger 14b which reciprocates inside the cylinder 14a in accordance with the rotation of the pump driving cam 12, a high-pressure chamber 14c defined by the plunger 14b in the interior of the cylinder 14a, and a spring 14d which urges the plunger 14b toward the pump driving cam 12.

The pump driving cam 12 is formed integrally with a camshaft 13 for opening and closing an intake valve of the internal combustion engine. The intake valve camshaft 13 is driven to rotate by a crankshaft via a sprocket and a chain or belt, and performs a single revolution for every two revolutions of the crankshaft.

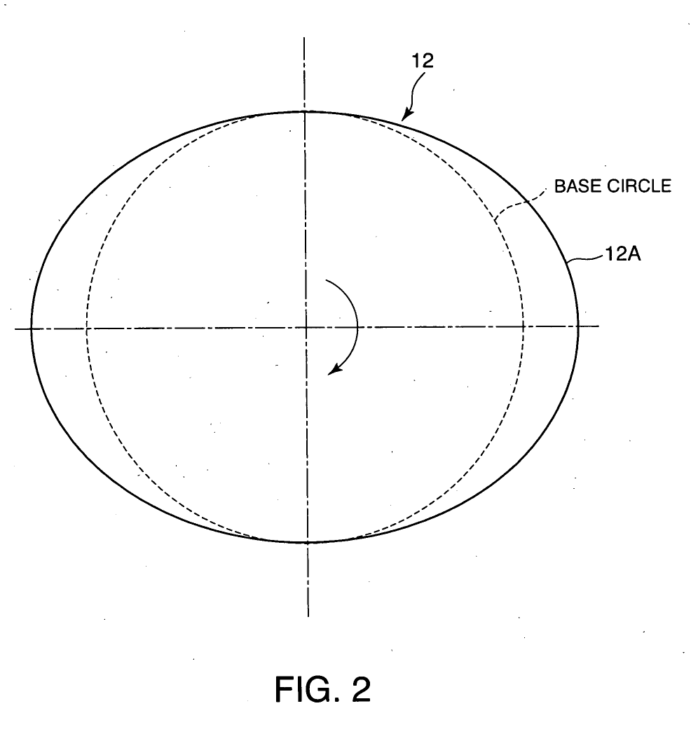

Referring to FIG. 2, the pump driving cam 12 takes an elliptical form, and comprises projecting portions 12A at 180 degree intervals at the two horizontal ends of a base circle indicated by a broken line.

As shown by the arrow in the figure, when the pump driving cam 12 rotates clockwise, the projecting portion 12A on the left side of the figure pushes the plunger 14b up such that the high-pressure chamber 14c is compressed. After the tip end of the projecting portion 12A has passed the plunger 14b, the plunger 14b descends as the pump driving cam 12 rotates.

Thus, every time the pump driving cam 12 rotates 180 degrees, or in other words every time the crankshaft performs a single revolution, the plunger 14b reciprocates within the cylinder 14a. In a suction stroke during which the plunger 14b descends, fuel is taken into the high-pressure chamber 14c from the fuel supply passage 8 via the suction check valve 15.

A control solenoid 17 is annexed to the check valve 15. The control solenoid 17, when excited, causes the check valve 15 to allow a reverse flow in the fuel supply passage 8. When the solenoid 17 is excited, the fuel in the high-pressure chamber 14c spills from the high-pressure chamber 14c into the fuel supply passage 8 as the plunger 14b rises. The damper 10 compensates for the increase in the fuel amount in the fuel supply passage 8. In contrast, when the solenoid 17 is not excited and accordingly the check valve 15 does not allow a reverse flow in the fuel supply passage 8, the fuel inside the high-pressure chamber 14c is pressurized as the plunger 14b rises and discharged via the check valve 16 into the common rail 21. These two operational states of the plunger pump 14 occurring when the plunger 14b rises will be referred to as a spill stroke and a discharge stroke. The plunger pump 14 is provided with a return passage 50 which returns the fuel leaked in the form of mist from a narrow gap between the plunger 15b and the cylinder 14 to the fuel tank 51.

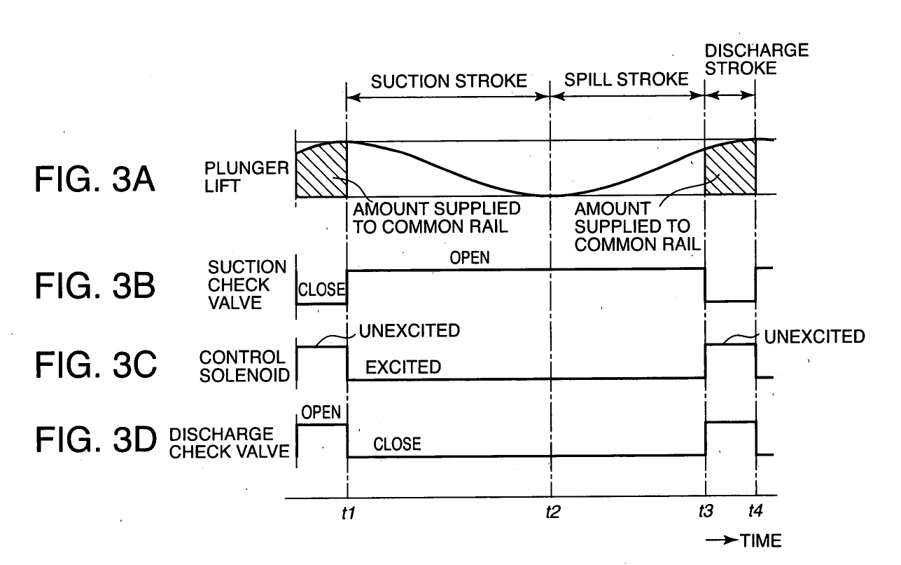

Referring to FIGS. 3A-3D, at a time t1, when the plunger 14b begins to descend from a top dead center position, the suction stroke begins, and the suction check valve 15 opens while the discharge check valve 16 closes. Hence, in the suction stroke, the fuel in the fuel supply passage 8 is taken into the expanding high-pressure chamber 14c through the suction check valve 15. The control solenoid 17 is excited at the time t1. At a time t2, after reaching a bottom dead center position, the plunger 14b begins to rise. At the bottom dead center position, since the control solenoid 17 is excited, the check valve 15 allows a reverse flow in the fuel supply passage 8. When the high-pressure chamber 14c is compressed by the rising plunger 14b, since the high-pressure chamber 14c is open to the fuel supply passage 8 via the check valve 15, the pressure in the high-pressure chamber 14c does not rise. At a time t3, the control solenoid 17 becomes unexcited, and hence the suction check valve 15 no more allows a reverse flow in the fuel supply passage 8 while the discharge check valve 16 opens. Thereafter, the fuel pressurized by the compressed high-pressure chamber 14c is supplied to the common rail 21 through the discharge check valve 16 until the plunger 14b reaches the top dead center position again at a time t4. The section from the time t2 to the time t3 is the spill stroke, and the section from the time t3 to the time t4 is the discharge stroke.

By advancing the time t3 at which the control solenoid 17 causes the check valve 15 to prevent a reverse flow in the fuel supply passage 8, the discharge amount of the plunger pump 14 is increased, and by retarding the time t3, the discharge mount of the plunger pump 14 is reduced. Hence, by advancing or retarding the timing at which the control solenoid 17 causes the check valve 15 to prevent a reverse flow in the fuel supply passage 8, the discharge amount of the high-pressure fuel pump unit 11 can be controlled.

The common rail 21 temporarily stores the fuel supplied from the high-pressure fuel pump unit 11 via an orifice 19, and then supplies the fuel to the fuel injectors 31A-31D.

Referring again to FIG. 1, the fuel injectors 31A-31D inject the fuel into the respective cylinders of the four-cylinder internal combustion engine in accordance with individually input fuel injection pulse width signals. When the fuel injectors 31A-31D inject the fuel, the fuel pressure in the common rail 21 decreases. The decreased fuel pressure recovers when fuel is supplied again by the high-pressure fuel pump 11.

A safety valve 22 is annexed to the common rail 21. The safety valve 22 opens when the fuel pressure in the common rail 21 exceeds an allowable pressure, and as a result, a part of the fuel in the common rail 21 is returned to the fuel tank 51.

Control of the electric motor 3 which drives the feed pump 2, control of the discharge amount of the high-pressure fuel pump unit 11 in accordance with the excitation of the control solenoid 17, and output of the fuel injection pulse width signals to the fuel injectors 31A-31D are executed by an engine controller 41.

The engine controller 41 is constituted by a microcomputer comprising a central processing unit (CPU), a read-only memory (ROM), a random access memory (RAM), and an input/output interface (I/O interface). The controller may be constituted by a plurality of microcomputers.

To perform the control described above, detection data from a fuel pressure sensor 42 which detects the fuel pressure of the common rail 21, a crankshaft rotation position sensor 43 which detects a rotation position of the crankshaft of the engine, an accelerator pedal depression amount sensor 44 which detects the depression amount of an accelerator pedal provided in the vehicle, a camshaft rotation position sensor 45 which detects a rotation position of the camshaft of the engine, and a starter switch 46 which detects cranking of the engine are input respectively into the engine controller 41 as signals.

The engine controller 41 causes fuel to be injected into each cylinder by opening the fuel injectors 31A-31D at a preset injection timing of each cylinder.

Further, a map of a target fuel pressure of the common rail 21, which is set in accordance with the engine load and rotation speed, is stored in the memory (ROM) of the engine controller 41. By referring to this map, the engine controller 41 calculates the target fuel pressure on the basis of the engine load, which is obtained from the accelerator pedal depression amount, and the engine rotation speed, which is obtained from the crankshaft rotation position. The engine controller 41 then controls the discharge amount of the high-pressure fuel pump unit 11 via the control solenoid 17 such that the fuel pressure of the common rail 21 is maintained at the target fuel pressure.

For example, when the fuel pressure of the common rail 21 is lower than the target fuel pressure, the engine controller 41 increases the discharge amount of the high-pressure fuel pump unit 11 by advancing the timing at which the control solenoid 17 causes the check valve 15 to prevent a reverse flow in the fuel supply passage 8, thereby raising the fuel pressure of the common rail 21. When the fuel pressure of the common rail 21 is higher than the target fuel pressure, the engine controller 41 reduces the discharge amount of the high-pressure fuel pump unit 11 by retarding the timing at which the control solenoid 17 causes the check valve 15 to prevent a reverse flow in the fuel supply passage 8 timing, thereby reducing the fuel pressure of the common rail 21.

By determining the engine load and engine rotation speed, the required fuel amount per cylinder cycle is determined uniquely. Further, the fuel injection pulse width of the fuel injectors 31A-31D is determined by determining the required fuel amount per cylinder cycle and the fuel pressure of the common rail 21. The engine controller 41 determines the required fuel amount per cylinder cycle from the engine load and engine rotation speed by referring to a map of the required fuel amount per cylinder cycle, which is stored in the memory (ROM) in advance. Further, the engine controller 41 calculates the fuel injection pulse width of the fuel injectors 31A-31D from the required fuel amount per cylinder cycle and the fuel pressure of the common rail 21, and at a predetermined injection timing, outputs a fuel injection pulse width signal corresponding to the fuel injection pulse width to the fuel injectors 31A-31D of each cylinder.

This embodiment is set such that during cranking of the engine, the fuel injectors 31A-31D perform fuel injection in the compression stroke of each cylinder, thereby generating stratified charge combustion.

The engine controller 41 converts a fuel injection pulse width Ti corresponding to the required fuel amount into a crank angle using the engine rotation speed. When a fuel injection end timing is fixed, a fuel injection start timing can be calculated by subtracting the conversion value from the fuel injection end timing.

The engine controller 41 calculates the fuel injection start timing at a timing that is advanced in relation to the actual injection timing by a predetermined crank angle. As a result, a time deviation exists between the calculation timing and the actual fuel injection start timing.

If the pressure of the common rail 21 rises during this deviation, an error may occur in the determination as to whether or not to permit compression stroke injection, leading to an increase in the time period from cranking to the start of combustion by the engine. An error also occurs in the calculation of the fuel injection pulse width.

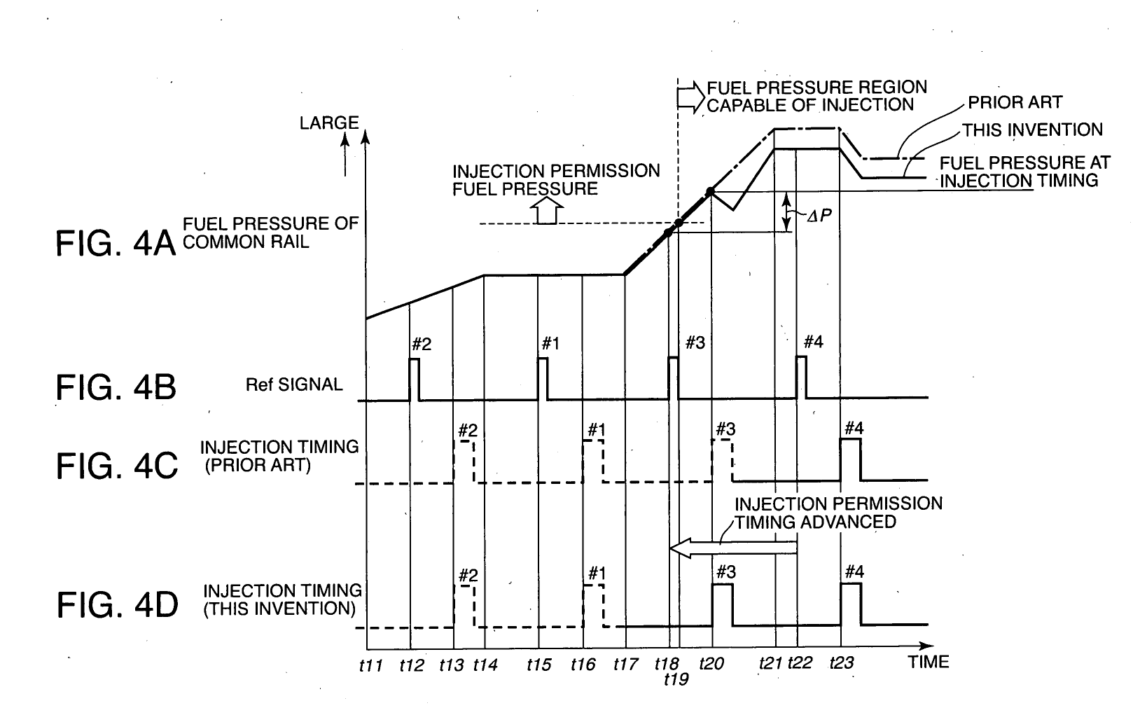

Referring to FIGS. 4A-4D, this phenomenon will now be described in detail.

FIG. 4A shows variation in the fuel pressure of the common rail 21 after the starter switch 46 is switched ON at a time t11 and engine cranking begins. At the same time as the starter switch 46 turns ON, the high-pressure fuel pump unit 11 begins to operate, and the fuel pressure of the common rail 21 rises from the time t11 to a time t14. From the time t14 to a time t17, the fuel pressure of the common rail 21 remains constant, then rises again from the time t17 to a time t21, and then remains constant from the time t21.

When the fuel pressure variation of the common rail 21 is associated with the plunger lift shown in FIG. 3A, the section from the time t11 to the time t14 and the section from the time t17 to the time t21 in FIG. 4A correspond to the discharge stroke of the high-pressure fuel pump unit 11, while the section from the time t14 to the time t17 and the section from the time t21 onward in FIG. 4A correspond to the suction stroke or the spill stroke of the high-pressure fuel pump unit 11.

Here, the calculation timing of the fuel injection timing is set to the rise timing of a Ref signal of each cylinder, and at this calculation timing, a determination is made as to whether or not to permit fuel injection. The Ref signal is a well-known signal indicating a reference crank angle position of each cylinder. It is assumed here that the Ref signal rises at 110 degrees before compression top dead center in each cylinder of the four-cylinder engine.

In FIG. 4B, the Ref signal rises at a time t22 in relation to a cylinder #4, and the determination as to whether or not to permit fuel injection is made by comparing the fuel pressure of the common rail 21 at this time with the predetermined injection permission fuel pressure. In this case, the fuel pressure of the common rail 21 takes the same value at a time t23, which is the fuel injection start timing of the cylinder #4, as that of a time t22, i.e. the calculation timing. Hence, in this case, when the determination as to whether or not to permit fuel injection is made or the fuel injection pulse width is calculated at the calculation timing t22 of the cylinder #4, the determination result or calculation result applies as is to the condition at the time t23, i.e. the actual fuel injection start timing.

Similarly in the case of a cylinder #1, the determination as to whether or not to permit fuel injection is made by comparing the fuel pressure of the common rail 21 at a time t15, i.e. the calculation timing, with the injection permission fuel pressure. In this case also, the fuel pressure of the common rail 21 takes the same value as that of the time t15, i.e. the calculation timing, at a time t16, which is the fuel injection start timing of the cylinder #1. Hence, in this case also, when the determination as to whether or not to permit fuel injection is made or the fuel injection pulse width is calculated at the calculation timing t15 of the cylinder #1, the determination result or calculation result applies as is to the condition at the time t16, i.e. the actual fuel injection start timing.

In a cylinder #3, on the other hand, a calculation timing t18 and an actual fuel injection timing t20 are positioned within the discharge stroke from the time t17 to the time t21. Here, when the determination as to whether or not to permit fuel injection is made by comparing the fuel pressure of the common rail 21 at the time t18 with the injection permission fuel pressure, the fuel pressure of the common rail 21 at the time t18 is very slightly lower than the injection permission fuel pressure. Therefore, fuel injection is not permitted, and fuel injection into the cylinder #3 is not performed at the fuel injection timing t20.

FIG. 4C shows the fuel injection timing of each cylinder according to the aforementioned prior art. Here, the solid line denotes executed fuel injection, and the broken line denotes fuel injection that is not permitted and therefore not performed. The sequence of fuel injection timings from the cranking start time t11 is cylinder #2, cylinder #1, cylinder #3, cylinder #4, but with regard to the cylinders #2, #1, and #3, the fuel pressure of the common rail 21 at the respective calculation timings is below the injection permission fuel pressure, and therefore fuel injection is not permitted. The fuel pressure of the common rail 21 first exceeds the injection permission fuel pressure at the time t22, which is the calculation timing of the cylinder #4, and hence at the time t23, the first fuel injection is performed into the cylinder #4. In reality, however, the fuel pressure of the common rail 21 exceeds the injection permission fuel pressure at the time t20, which is the actual fuel injection timing of the cylinder #3, and therefore the fuel injector 31C of the cylinder #3 is perfectly capable of fuel injection at this time. In other words, in the prior art, fuel injection is not begun until the time t23, even though fuel injection is possible at the time t20.

To prevent such unnecessary delays in fuel injection during cranking, in this invention the fuel pressure at the actual fuel injection timing is predicted by the engine controller 41 at the calculation timing of each cylinder so as to increase the calculation precision of the fuel injection amount, or in other words the fuel injection pulse width. Further, the determination as to whether or not to permit fuel injection is made by comparing the predicted pressure with the injection permission fuel pressure.

Moreover, when fuel injection is permitted, the predicted pressure is used to calculate the fuel injection pulse width. Thus, in contrast to the prior art, the predicted pressure of the common rail 21 at the fuel injection timing is used in place of the fuel pressure of the common rail 21 at the calculation timing as the basis for determining whether or not to permit fuel injection, and as a result, the timing at which fuel injection is possible during cranking can be grasped with precision, as shown in FIG. 4D, enabling unnecessary fuel injection delays to be prevented. Furthermore, by employing the predicted pressure at the fuel injection timing, the fuel injection amount can also be calculated with a high degree of precision.

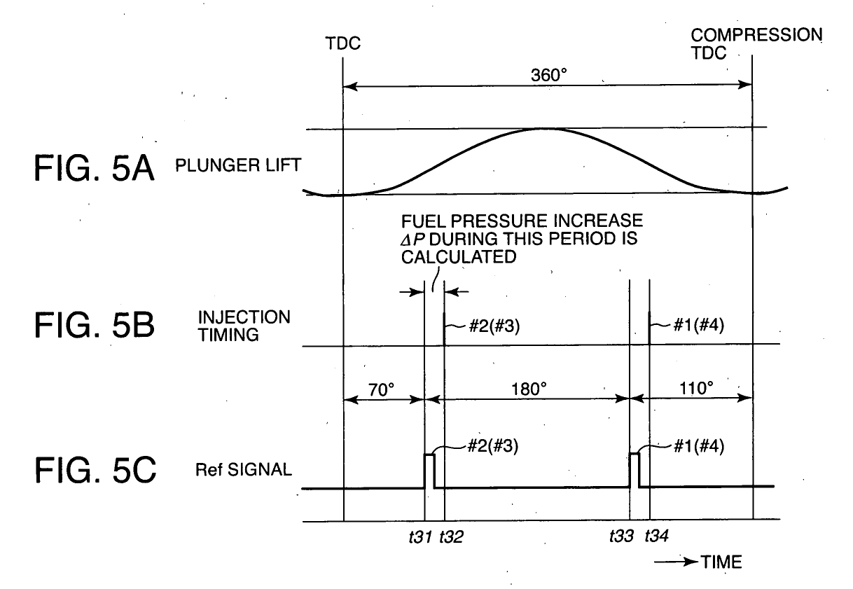

Calculation of the predicted pressure will now be described with reference to FIGS. 5A-5C.

FIG. 5A shows the plunger lift of the high-pressure fuel pump 14 in a 360 degree crank angle section. As described above, the intake valve camshaft 13 performs one revolution per two revolutions of the crankshaft, and the pump driving cam 12 lifts the high-pressure fuel pump 14 twice per revolution of the intake valve camshaft 13. As a result, one plunger lift cycle corresponds to a crank angle of 360 degrees. For ease of description, it is assumed that the cam profile of the pump driving cam 12 is set such that the plunger lift reaches zero at the compression top dead center position of the cylinder #1. As shown in FIG. 5C, it is assumed that the Ref signal of the cylinder #1 rises at a time t33, when the crank angle has advanced 110 degrees from compression top dead center.

If the cylinder combustion sequence, or in other words the fuel injection sequence, is assumed to be #1, #3, #4, #2, then the cylinder which is injected with fuel immediately before the cylinder #1 is the cylinder #2, and the Ref signal of the cylinder #2 rises at a time t31, which is 180 degrees prior to the Ref signal of the cylinder #1.

Meanwhile, as shown in FIG. 5B, the fuel injection timing of the cylinder #1 corresponds to a crank angle at a time t34, which is later than the rise timing t33 of the Ref signal of the cylinder #1, and the fuel injection timing of the cylinder #2 corresponds to a crank angle at a time t32, which is later than the rise timing t31 of the Ref signal of the cylinder #2.

As for the cylinder #3 and the cylinder #4, in the next plunger lift-cycle, the output timing for the Ref signal of the cylinder #3 matches the output timing for the Ref signal of the cylinder #2, and the output timing for the Ref signal of the cylinder #4 matches the output timing for the Ref signal of the cylinder #1. Furthermore, the fuel injection timing of the cylinder #3 matches the fuel injection timing of the cylinder #2 in the previous cycle, and the fuel injection timing of the cylinder #4 matches the fuel injection timing of the cylinder #1 in the previous cycle. Hence, on the timing chart, the fuel injection timing of the cylinder #2 (#3) corresponds to the time t32, which is later than the Ref signal rise timing t31, and the fuel injection timing of the cylinder #1 (#4) corresponds to the time t34, which is later than the Ref signal rise timing t33.

Here, in the cylinders whose Ref signal rise timing and injection timing are in the discharge stroke of the high-pressure fuel pump unit 11, i.e. the cylinder #2 and the cylinder #3, the fuel pressure of the common rail 21 at the time t32 is higher than the fuel pressure of the common rail 21 at the time t31. The engine controller 41 predicts the fuel pressure differential of the common rail 21 at the Ref signal rise timings t31 and t33, respectively.

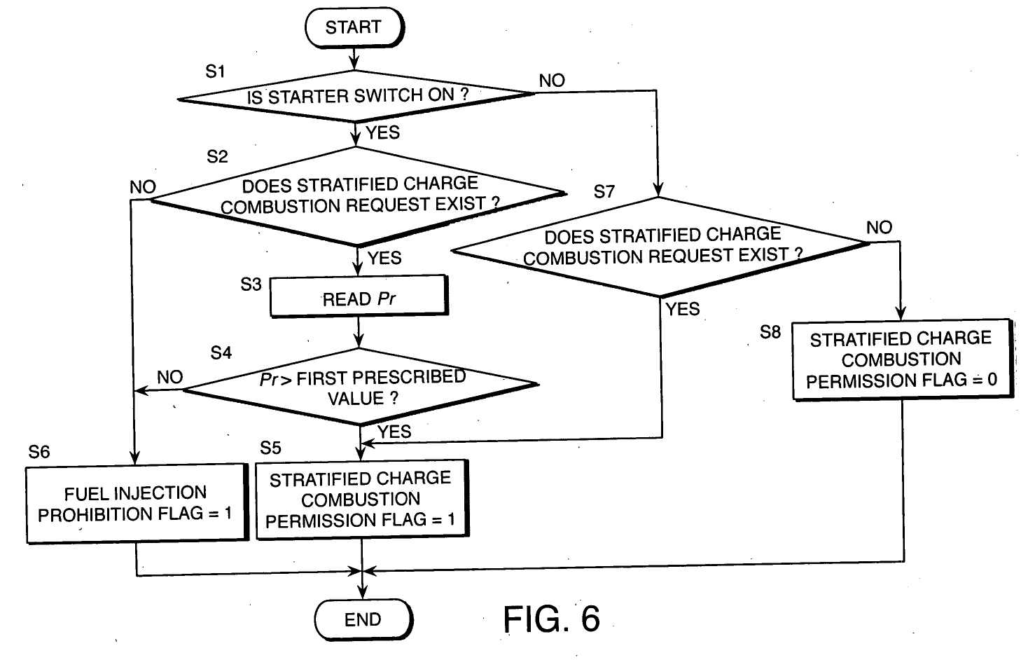

Next, referring to FIGS. 6-8, a stratified charge combustion permission flag setting routine, a fuel injection timing calculation routine, and a fuel injection routine, which are executed by the engine controller 41 in order to realize the fuel injection control described above, will be described.

FIG. 6 shows the stratified charge combustion permission flag setting routine. The engine controller 41 executes this routine repeatedly at ten millisecond intervals for the entire period in which an ignition switch of the vehicle is ON.

In a step S1, the engine controller 41 determines whether or not the starter switch 46 is ON. When the starter switch 46 is ON, it is determined that the engine is being cranked, and the engine controller 41 determines in a step S2 whether or not a stratified charge combustion request exists. In this case, the internal combustion engine is set to suppress fuel consumption by performing stratified charge combustion through compression stroke injection in a stratified charge combustion region set at low load and low engine rotation speed, and to maintain a high output by performing homogeneous combustion through intake stroke injection in a homogeneous combustion region set at high load or high engine rotation speed.

Hence, by referring to a combustion region map stored in the memory (ROM) in advance, the engine controller 41 determines whether or not the operating region of the engine corresponds to the stratified charge combustion region on the basis of the accelerator pedal depression amount, detected by the accelerator pedal depression amount sensor 44 and serving as a representative value of the engine load, and the engine rotation speed, detected by the crankshaft rotation position sensor 43, and when the determination is affirmative, the engine controller 41 determines that a stratified charge combustion request exists.

When a stratified charge combustion request exists, in a step S3 the engine controller 41 reads a current fuel pressure Pr of the common rail 21, detected by the fuel pressure sensor 42. The unit of the fuel pressure Pr is the pascal (Pa).

Next, in a step S4, the engine controller 41 determines whether or not the fuel pressure Pr is equal to or greater than a first prescribed value. Here, the first prescribed value is slightly lower than the aforementioned fuel injection permission pressure. A method of determining the first prescribed value will be described below.

The fuel injection amount injected by the fuel injectors 31A-31D into the corresponding cylinder per cycle is determined according to the fuel pressure of the common rail 21 and the fuel injection pulse width. A minimum fuel amount required to rotate the engine with stability by means of stratified charge combustion and a minimum fuel injection pulse width at which the opening precision of the fuel injectors 31A-31D is assured are determined respectively in advance. From these two values, a minimum value of the common rail 21 fuel pressure required to rotate the engine with stability by means of stratified charge combustion is determined. The first prescribed value corresponds to this minimum value.

When the fuel pressure Pr is equal to or greater than the first prescribed value, the engine controller 41 sets a stratified charge combustion permission flag to unity in a step S5, and then terminates the routine.

When the fuel pressure Pr is lower than the first prescribed value, the engine controller 41 determines that the operating conditions of the engine are not suitable for stratified charge combustion, and in a step S6 sets a fuel injection prohibition flag to unity, and then terminates the routine. Likewise when the determination of the step S2 is negative, or in other words when it is determined that a stratified charge combustion request does not exist, the engine controller 41 sets the fuel injection prohibition flag to unity in the step S6, and then terminates the routine.

The initial value of both the stratified charge combustion permission flag and the fuel injection prohibition flag is zero.

When the starter switch is not ON in the step S1, this indicates that the ignition switch is ON, and therefore that the internal combustion engine has completed cranking and is rotating under its own power. In this case, the engine controller 41 determines whether or not a stratified charge combustion request exists in a step S7, similarly to the step S2.

When the determination of the step S7 is affirmative, or in other words when a stratified charge combustion request exists, the engine controller 41 sets the stratified charge combustion permission flag to unity in the step S5, and then terminates the routine.

When the determination of the step S7 is negative, or in other words when no stratified charge combustion request exists, the engine controller 41 resets the stratified charge combustion permission flag to zero in a step S8, and then terminates the routine.

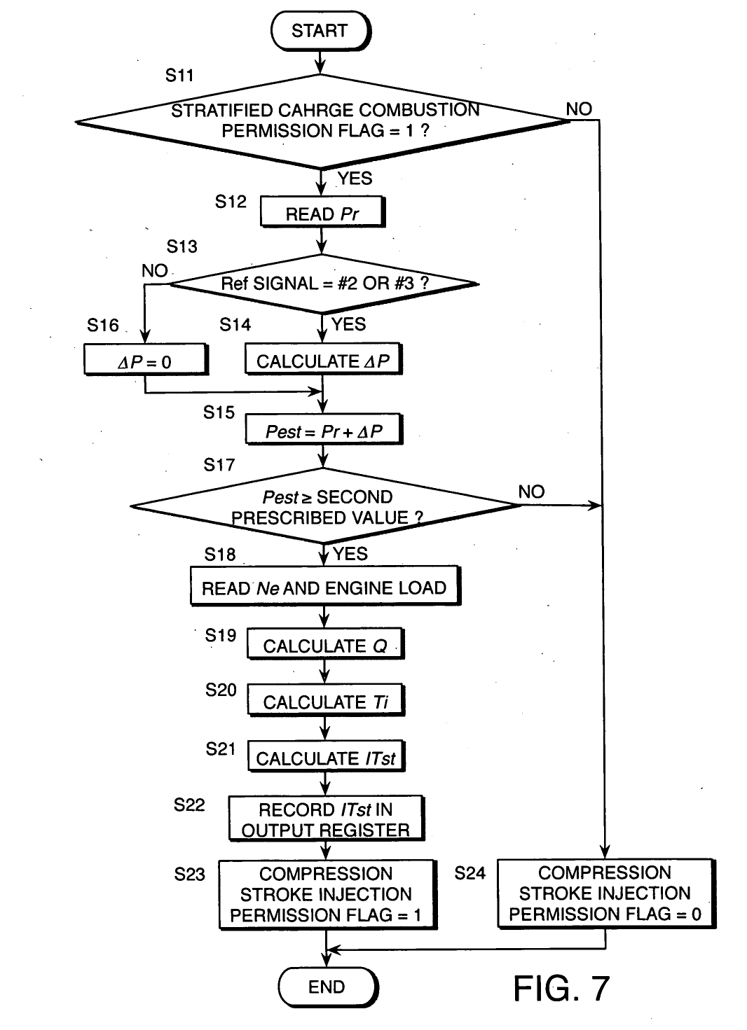

FIG. 7 shows the fuel injection timing calculation routine. The engine controller 41 executes this routine in synchronization with the rise of the Ref signal of each cylinder, or in other words at the calculation timing of each cylinder.

In a step S11, the engine controller 41 determines whether or not the stratified charge combustion permission flag is at unity. When the stratified charge combustion permission flag is not at unity, the engine controller 41 resets a compression stroke injection permission flag to zero in a step S24, and then terminates the routine.

On the other hand, when the stratified charge combustion permission flag is at unity in the step S11, in a step S12 the engine controller 41 reads the current fuel pressure Pr of the common rail 21, detected by the fuel pressure sensor 42.

The engine controller 41 then determines whether or not the Ref signal that serves as a trigger for execution of the current fuel injection timing calculation routine is the Ref signal of the cylinder #2 or the cylinder #3 in a step S13.

When the determination of the step S13 is affirmative, this indicates that the fuel pressure is rising, as explained with reference to FIGS. 5A-5C. When the determination of the step S13 is negative, this indicates that the fuel pressure is constant up to the fuel injection timing.

When the determination of the step S13 is affirmative, in a step S14 the engine controller 41 estimates a fuel pressure increase ΔP during a period extending from detection of the fuel pressure to fuel injection. As shown in a following equation (1), the fuel pressure increase ΔP may be calculated from a discharge amount ΔV of the high-pressure fuel pump unit 11 during this period and a volume V0 of the common rail 21.

$$Δ P = \frac{Δ V}{V 0} \cdot K 1 \qquad ( 1 )$$

where K1=a constant.

By determining the specifications of the high-pressure fuel pump unit 11 and common rail 21, the constant K1 can be determined through matching. As a result, the fuel pressure increase ΔP is expressed as a constant value.

When the specifications of the high-pressure fuel pump unit 11 and common rail 21 vary, the constant K1 also varies. The fuel pressure increase ΔP typically exhibits the following tendencies.

(1) As the plunger lift of the plunger pump 14 increases, the discharge amount ΔV of the high-pressure fuel pump unit 11 increases, and as a result, the fuel pressure increase ΔP also increases.

(2) As the volume of the plunger pump 14 increases, the discharge amount ΔV of the high-pressure fuel pump unit 11 increases, and as a result, the fuel pressure increase ΔP also increases.

(3) As the volume V0 of the common rail 21 increases, the fuel pressure increase ΔP decreases.

On the other hand, when the determination of the step S13 is negative, the engine controller 41 sets the fuel pressure increase ΔP to zero in a step S16.

Once the fuel pressure increase ΔP has been set in the step S14 or the step S16, in a step S15 the engine controller 41 calculates a predicted value Pest of the fuel pressure at the fuel injection timing, using a following equation (2).
Pest=Pr+ΔP (2)

Next, in a step S17, the engine controller 41 compares the predicted value Pest of the fuel pressure at the fuel injection timing with a second prescribed value. The second prescribed value is the aforementioned fuel injection permission pressure, and more specifically corresponds to a value of approximately several megapascals (MPa).

When the predicted value Pest has not reached the second prescribed value in the step S17, the engine controller 41 resets the compression stroke injection permission flag to zero in the step S24, and then terminates the routine.

When the predicted value Pest has reached the second prescribed value in the step S17, the engine controller 41 reads an engine rotation speed Ne and engine load in a step S18. The engine rotation speed Ne is a value obtained from the crankshaft rotation position, which is detected by the crankshaft rotation position sensor 43. The accelerator pedal depression amount detected by the accelerator pedal depression amount sensor 44 is used as the engine load.

Next, in a step S19, the engine controller 41 determines a required fuel amount Q (milligrams/cycle) per cylinder cycle from the engine rotation speed Ne and engine load by referring to a map stored in the memory (ROM) in advance. In this map, the required fuel amount Q per cylinder cycle has a characteristic of increasing as the engine load increases when the engine rotation speed Ne is constant.

In a step S20, the engine controller 41 calculates a fuel injection pulse width Ti (milliseconds) using the required fuel amount Q per cylinder cycle and the predicted value Pest of the fuel pressure at the fuel injection timing, in accordance with a following equation (3).

$$Ti = \frac{K 2}{Pest} \cdot K 2 \qquad ( 3 )$$

where K2=a constant.

The equation (3) is determined in the following manner. The required fuel amount Q (milligrams/cycle) per cylinder cycle is proportionate to a fuel pressure P (Pa) of the common rail 21 and the fuel injection pulse width Ti (milliseconds), as shown in a following equation (4).
Q=PTiC (4)

where C=a constant of proportionality.

By solving the equation (3) for the fuel injection pulse width Ti, a following equation (5) is obtained.

$$Ti = \frac{1}{C} \cdot \frac{Q}{P} \qquad ( 5 )$$

By replacing

$$\frac{1}{C}$$

in the equation (5) with K2, the equation (3) is obtained.

In a step S21, the engine controller 41 converts the fuel injection pulse width Ti (milliseconds) into a crank angle using the engine rotation speed Ne, and determines a fuel injection start timing ITst (degrees before top dead center (°BTDC)) by subtracting the conversion value from a fuel injection end timing ITend (°BTDC). Here, the fuel injection end timing ITend is a fixed value advanced by a predetermined crank angle from the compression top dead center of each cylinder. Accordingly, the fuel injection start timing ITst is also a value advanced from compression top dead center.

In a step S22, the engine controller 41 records the fuel injection start timing ITst in an output register.

In a step S23, the engine controller 41 sets the compression stroke injection permission flag to unity, and then terminates the routine.

This routine relates to setting of the fuel injection start timing when the stratified charge combustion permission flag is at unity. When the stratified charge combustion permission flag is at zero and the compression stroke injection permission flag is set to zero in the step S24, a combustion start timing for homogeneous combustion is calculated in a separate routine. This invention relates to fuel injection during engine cranking, and in this embodiment, compression stroke injection is performed during engine cranking. Accordingly, a description of fuel injection control for homogeneous combustion has been omitted.

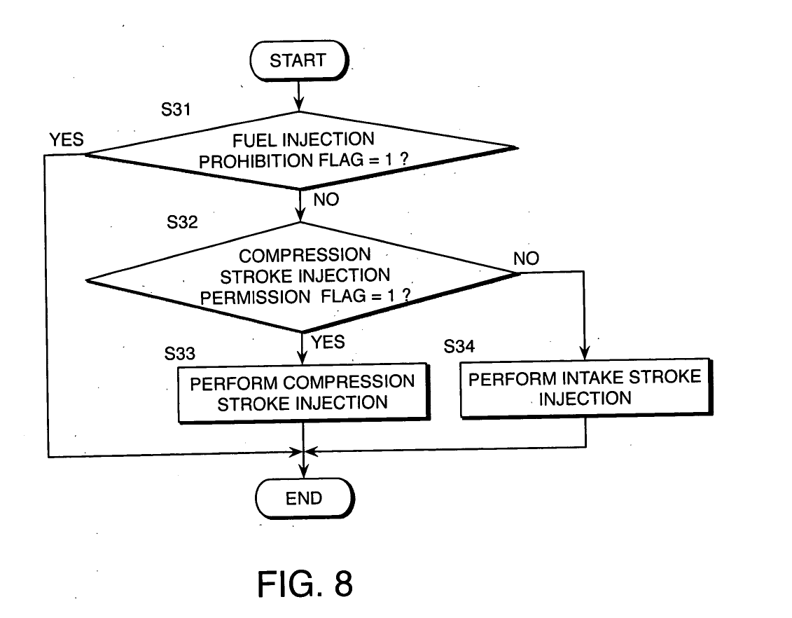

FIG. 8 shows the fuel injection routine. The engine controller 41 executes this routine upon termination of the routine of FIG. 7 or the routine for calculating the fuel injection start timing for homogeneous combustion.

In a step S31, the engine controller 41 determines whether or not the fuel injection prohibition flag is at unity. When the fuel injection prohibition flag is at unity, the engine controller 41 immediately terminates the routine.

When the fuel injection prohibition flag is not at unity, the engine controller 41 determines whether or not the compression stroke injection permission flag is at unity in a step S32.

When the compression stroke injection permission flag is at unity, in a step S33 the engine controller 41 executes fuel injection on the basis of the fuel injection start timing ITst, calculated in the routine of FIG. 7, and fuel injection end timing ITend.

When the compression stroke injection permission flag is not at unity, in a step S34, the engine controller 41 executes fuel injection in accordance with the fuel injection start timing calculated in the routine for calculating the fuel injection start timing for homogeneous combustion.

Following the processing of the step S33 or S34, the engine controller 41 terminates the routine.

According to this invention, as described above, the fuel pressure at the fuel injection timing is predicted by increasing the measured fuel pressure of the cylinders #2, #3 in which fuel injection is performed in the discharge stroke of the plunger pump 14. The determination as to whether or not to permit fuel injection, and calculation of the fuel injection amount when fuel injection is permitted, are, then performed on the basis of the predicted fuel pressure. Hence, errors in the fuel injection determination and fuel injection amount calculation, which are caused by a deviation between the fuel pressure detection timing and the fuel injection timing, can be reduced, and the fuel injection start timing during engine cranking can be determined accurately. As a result, as shown in FIG. 4D, fuel injection starts from the cylinder #3, into which fuel injection is not performed in the prior art, and therefore the amount of time required for engine cranking can be shortened. Moreover, the fuel injection amount calculation precision is improved.

The contents of Tokugan 2005-134145, with a filing date of May 2, 2005 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

For example, in the embodiment described above, this invention is applied to an internal combustion engine which performs compression stroke injection/stratified charge combustion during cranking, but this invention may also be applied to an engine which performs intake stroke injection/homogeneous combustion during cranking. In this case also, the fuel injection start timing can be advanced and the fuel injection amount calculation precision can be improved by employing the predicted value Pest of the fuel pressure at the fuel injection timing when determining fuel injection permission and setting the fuel injection start timing.

In the embodiment described above, the fuel injection start timing is determined by applying this invention to an engine having a fixed fuel injection end timing, but it is also possible to determine the fuel injection end timing by applying this invention to an engine having a fixed fuel injection start timing.

In the embodiment described above, the rise timing of the Ref signal is used as the calculation timing, but the fall timing of the Ref signal may be used as the calculation timing, or the calculation timing may be set independently of the Ref signal. In short, this invention can be applied to any fuel injection control device which calculates a fuel injection amount at a timing prior to the beginning of fuel injection.

In the embodiment described above, the plunger pump 14 driven by the pump driving cam 12 is used in the high-pressure fuel pump unit 11, but another type of pump, for example a swash plate pump, may be used in the high-pressure fuel pump unit 11. Alternatively, the pump driving cam 12 may be formed integrally with an exhaust valve opening/closing cam shaft instead of the intake valve opening/closing camshaft 13. This invention is also applicable to an engine in which fuel is supplied to the fuel injectors 31A-31D without passing through the common rail 21.

The embodiments of this invention in which an exclusive property or privilege is claimed are defined as follows:

What is claimed is:

1. A fuel supply control device for controlling fuel supply to an internal combustion engine while the engine is being cranked, comprising:
a reciprocation pump which pressurizes, according to the rotation of the engine, fuel which is to be supplied to the engine;
a fuel injector which injects the fuel pressurized by the reciprocation pump into a cylinder of the engine at a predetermined crank angle of the engine; and
a programmable controller programmed to:
predict a pressure of the fuel pressurized by the reciprocation pump at a fuel injection timing corresponding to the predetermined crank angle of the engine as a predicted fuel pressure, at a predetermined calculation timing which is prior to the fuel injection timing; and
control the fuel injector to perform fuel injection when the predicted fuel pressure reaches a predetermined injection permission pressure.

2. The fuel supply control device as defined in claim 1, wherein the engine comprises a plurality of cylinders, and the controller is further programmed to:
distinguish between a fuel discharge stroke of the reciprocation pump and a stroke other than the discharge stroke; execute fuel injection in relation to cylinders in which fuel injection is performed in the discharge stroke when the predicted fuel pressure reaches the predetermined injection permission pressure; and
execute fuel injection in relation to cylinders in which fuel injection is performed in the stroke other than the discharge stroke when a fuel pressure detected at the predetermined calculation timing reaches the predetermined injection permission pressure.

3. The fuel supply control device as defined in claim 1, wherein the fuel injection timing corresponds to a compression stroke of the cylinder.

4. The fuel supply control device as defined in claim 1, wherein the controller is further programmed to predict the fuel pressure at the fuel injection timing by adding an increase in the fuel pressure between the calculation timing and the fuel injection timing to a fuel pressure detected at the predetermined calculation timing.

5. The fuel supply control device as defined in claim 4, wherein the increase is set to a value which increases as a volume of the reciprocation pump increases.

6. The fuel supply control device as defined in claim 4, wherein the increase is set to a value which increases as a discharge amount of the reciprocation pump increases.

7. The fuel supply control device as defined in claim 4, wherein the engine comprises a common rail which temporarily stores the fuel discharged by the reciprocation pump and then supplies the fuel to the fuel injector, and the increase is set to a value which decreases as a volume of the common rail increases.

8. The fuel supply control device as defined in claim 1, wherein the controller is further programmed to determine a fuel injection amount of the fuel injector on the basis of the predicted fuel pressure.

9. The fuel supply control device as defined in claim 1, wherein the controller is further programmed to prohibit fuel injection by the fuel-injector when a fuel pressure detected at the predetermined calculation timing is lower than a first prescribed value that is smaller than the predetermined injection permission pressure.

10. A fuel supply control device for controlling fuel supply to an internal combustion engine while the engine is being cranked, comprising:
a reciprocation pump which pressurizes, according to the rotation of the engine, fuel which is to be supplied to the engine;
a fuel injector which injects the fuel pressurized by the reciprocation pump into a cylinder of the engine at a predetermined crank angle of the engine;
means for predicting a pressure of the fuel pressurized by the reciprocation pump at a fuel injection timing corresponding to the predetermined crank angle of the engine as a predicted fuel pressure, at a predetermined calculation timing which is prior to the fuel injection timing; and
means for controlling the fuel injector to perform fuel injection when the predicted fuel pressure reaches a predetermined injection permission pressure.

11. A fuel supply control method for controlling fuel supply to an internal combustion engine while the engine is being cranked, using a reciprocation pump which pressurizes, according to the rotation of the engine, fuel which is to be supplied to the engine, and a fuel injector which injects the fuel pressurized by the reciprocation pump into a cylinder of the engine at a predetermined crank angle of the engine, the method comprising:
predicting a pressure of the fuel pressurized by the reciprocation pump at a fuel injection timing corresponding to the predetermined crank angle of the engine as a predicted fuel pressure, at a predetermined calculation timing which is prior to the fuel injection timing; and
controlling the fuel injector to perform fuel injection when the predicted fuel pressure reaches a predetermined injection permission pressure.
